(19) United States
(12) Patent Application Publication
(10) Pub. No.: US 2013/0110873 A1
(43) Pub. Date: May 2, 2013

(54) METHOD AND SYSTEM FOR DATA STORAGE AND MANAGEMENT

(71) Applicants: Xeround Systems Ltd., Yahud (IL); Xeround Inc., Mountain View, CA (US)

(72) Inventors: Yaniv ROMEM, Jerusalem (IL); IIia GILDERMAN, Jerusalem (IL); Zohar LEV-SHANI, Modiln (IL); Avi VIGDER, Savyon (IL); Eran LEISEROWITZ, Kiryat-Ono (IL); Gilad ZLOTKIN, Mevasseret Zion (IL)

(73) Assignees: Xeround Inc., Mountain View, CA (US); Xeround Systems Ltd., Yahud (IL)

(21) Appl. No.: 13/717,738

(22) Filed: Dec. 18, 2012

Related U.S. Application Data
(63) Continuation of application No. 12/216,297, filed on Jul. 2, 2008.
(60) Provisional application No. 60/929,560, filed on Jul. 3, 2007.

(51) Int. Cl. G06F 17/30

(52) U.S. Cl. CPC G06F 17/30339
USPC 707/771

(57) ABSTRACT

According to some embodiments of the present invention there is provided a method and a system for managing data storage in a plurality of data partitions, such as replica databases. The method is based on analyzing, for each physical data partition, the received memory access queries. Each memory access query has a different result table which is based on different fields. This analysis is performed to determine the frequency of receiving each one of the memory access queries. The analysis allows, for one or more of the analyzed memory access queries, associating between at least one key of a respective result table and at least one of the physical data partitions. In such an embodiment, data elements are stored according to a match with respective said at least one key.

### RELATED APPLICATIONS

This application is a continuation of U.S. patent application Ser. No. 12/216,297 filed on Jul. 2, 2008, which claims the benefit of priority under 35 USC §119(e) of U.S. Provisional Patent Application No. 60/929,560 filed on Jul. 3, 2007. The contents of the above applications are all incorporated by reference as if fully set forth herein in their entirety.

### FIELD AND BACKGROUND OF THE INVENTION

The present invention relates to an apparatus and method for managing a storage of data elements, and more particularly, but not exclusively to an apparatus and method for managing the distribution of data elements across a number of storage devices.

To date, digital data to which rapid and accurate access by large numbers of users is required may be stored in autonomous or distributed databases. An autonomous database is stored on an autonomous storage device, such as a hard disk drive (HDD) that is electronically associated with a hosting computing unit. A distributed database is stored on a distributed database that comprises a number of distributed storage devices, which are connected to one another by a high-speed connection.

The distributed databases are hosted by the distributed storage devices, which are positioned either in a common geographical location or at remote locations from one another.

There are a number of known methods and systems for managing data in distributed databases. For example, a relational database management system (RDBMS) manages data in tables. When such a management is implemented, each logical storage unit is associated with one or more physical data storages where the data is physically stored. Usually, the data, which is stored in a certain physical data storage, is associated with a number of applications which may locally or remotely access it. In such case, the records which are stored in the certain physical data storage are usually selected according to their relation to a certain table and/or their placing a certain table, such as a proxy table. Such a storing is a generic solution for various applications as it does not make any assumptions regarding the transactions which are performed.

In relational databases, tables may refer to one another, usually using referential constraint such as foreign keys. In some applications, most of the queries to and transactions are based on a common the referential constraint such as the primary key. For example, in databases of cellular carriers a unique client identifier (ID) is used. The data is usually distributed in a normalized manner between groups of related tables.

A general approach for implementing a real-time highly-available distributed data management system that uses three or more backup copies is disclosed in pending International Patent Application Publication No. WO2006/090367, filed on Nov. 7, 2005, which is hereby incorporated by reference in its entirety and discloses a system having database units arranged in virtual partitions, each independently accessible, a plurality of data processing units, and a switching network for switching the data processing units between the virtual partitions, thereby to assign data processing capacity dynamically to respective virtual partitions. In such an embodiment, a majority-voting process is used in order to validate the different data replicas in each virtual partition. Majority of the data replicas are sufficient for assuring safe completion of any read or write operation transaction while guaranteeing consistent data integrity and the atomicity of each transaction.

Such data systems may be used for maintaining critical real-time data are expected to be highly available, highly scalable and highly responsive. The responsiveness requirement may suggest allocating and devoting a dedicated computing resource for a transaction to make sure it is completed within the required amount of time. The high availability requirement, on the other side, would typically suggest storing every mission critical data item on highly available storage device, which means that every write transaction needs to be written into the disk before it is committed and completed. Otherwise, the data will not be available in case the writing computing element has failed. This strategy reduces the transaction rate achieved even when running on large computing servers with many CPUs. In many cases, mission critical data repositories are accessed by several different computing entities (“clients”) simultaneously for read/write transactions and therefore distributed data repositories also need to provide system-wide consistency. A data repository is considered to be “consistent” (or “sequential consistent”), if from the point of view of each and every client, the sequence of changes in each data element value is the same.

A plurality of methods are used to generate a backup of the database, e.g. for to disaster recovery. Typically, either a new file is generated by the backup process or a set of files can be copied for this purpose. Recently, incremental and distributed backup processes have become more widespread as a means of making the backup process more efficient and less time consuming.

### SUMMARY OF THE INVENTION

According to some embodiments of the present invention there is provided a method for managing data storage in a plurality of physical data partitions. The method comprises, for each the physical data partition, calculating a frequency of receiving each of a plurality of memory access queries, for at least one the memory access query, associating between at least one key of a respective result table and at least one of the plurality of physical data partitions according to respective the frequency, and storing a plurality of data elements in at least one of the plurality of data partitions according to a match with respective the at least one associated key.

Optionally, each the physical data partition is independently backed up.

Optionally, the associating comprising associating at least one data field having a logical association with the at least one key, each the data element being stored according to a match with respective the at least one key and the at least one logically associated data field.

More optionally, a first of the logically associated data fields is logically associated with a second of the logically associated data fields via at least one third of the logically associated data field.

More optionally, the logical association is selected according to a logical schema defining a plurality of logical relations among a plurality of data fields and keys.

Optionally, the associating comprises generating a tree dataset of a plurality of keys, the at least one key being defined in the plurality of keys.

More optionally, each record of the tree dataset is associated a respective record in a relational schema, further comprising receiving a relational query for a first of the plurality of data elements and acquiring the first data element using a respective association between the relational schema and the tree dataset.

More optionally, each record of the tree dataset is associated a respective record in an object schema, further comprising receiving a relational query for a first of the plurality of data elements and acquiring the first data element using a respective association between the object schema and the tree dataset.

Optionally, the associating is based on statistical data of the plurality of memory access queries.

According to some embodiments of the present invention there is provided a method for retrieving at least one record from a plurality of replica databases where each having a copy of each of a plurality of records. The method comprises time tagging the editing of each the record with a first time tag and the last editing performed in each the replica database with a second time tag, receiving a request for a first of the plurality of records and retrieving a respective the copy from a at least one of the plurality of replica databases, and validating the retrieved copy by matching between a respective the first tag and a respective the second tag.

Optionally, each the second time tag is a counter and each the first time tag is a copy of the second time tag at the time of respective the last editing.

Optionally, the method is implemented to accelerate a majority voting process.

Optionally, the retrieving comprises retrieving a plurality of copies of the first record, further comprising using a majority-voting algorithm for confirming the first record if the validating fails.

According to some embodiments of the present invention there is provided a method for validating at least one record of a remote database. The method comprises forwarding a request for a first of a plurality of records to a first network node hosting an index of the plurality of records, the index comprises at least one key of each the record as an unique identifier, receiving an index response from the first network node and extracting respective the at least one key therefrom, acquiring a copy of the first record using the at least one extracted key, and validating the copy by matching between values in respective the at least one key of the copy and the index response.

Optionally, the index is arranged according to a hash function.

Optionally, the forwarding comprises forwarding the request to a plurality of network nodes each hosting a copy of the index, the receiving comprises receiving at least one index response from the plurality of network nodes and extracting respective to the at least one key from the at least one index response.

More optionally, if the validating fails a majority voting process is performed on the at least one index.

More optionally, if the validating fails each the at least one index is used for acquiring a copy of the first record using the at least one extracted key, the validating further comprising using a majority voting process on the acquired copies.

According to some embodiments of the present invention there is provided a method for retrieving records in a distributed data system. The method comprises receiving a request for a first of a plurality of records at a front end node of the distributed data system, forwarding the request to a storage node of the distributed data system, the storage node hosting an index, and using the storage node for extracting a reference for the first record from the index and sending a request for the first record accordingly.

Optionally, the forwarding comprises forwarding the request to a plurality of storage nodes of the distributed data system, each the storage node hosting a copy of the index. The using comprises using each the storage node for extracting a reference for the first record from respective the index and sending a respective request for the first record accordingly, the receiving comprising receiving a response to each the request.

Optionally, the method further comprises validating the responses using a majority voting process.

According to some embodiments of the present invention there is provided a system for backing up plurality of virtual partitions. The system comprises a plurality replica databases configured for storing a plurality of virtual partitions having a plurality of data elements, each data element of the virtual partition being separately stored in at least two of the plurality replica databases and a data management module configured for synchronizing between the plurality of data elements of each the virtual partition, and at least one backup agent configured for managing a backup for each the virtual partition in at least one of the replica database. The data management module is configured for synchronizing the at least one backup agent during the synchronizing, thereby allowing the managing.

Optionally, the at least one backup agent are configured to allow the to generation of an image of the plurality of virtual partitions from the backups.

Optionally the data management module is configured for logging a plurality of transactions related to each the virtual partition in respective the backup.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

In most implementations of distributed data repositories supporting many concurrent clients that perform write transactions, the consistency requirement is also a limiting factor for system scalability in terms of transaction rate. This is because to write transactions need to be serialized and read transaction typically have to be delayed until pending write transactions have been completed. The serialization of read/write transactions is typically done also when different transactions access different data elements (i.e. independent transactions), due to the way the data is organized within the system (e.g. on the same disk, in the same memory, etc.). In real-time systems data is typically accessed via indexes.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for managing data in a plurality of data partitions, according to some embodiments of the present invention;

FIG. 2 is a schematic illustration of an exemplary storage system for managing a plurality of data elements which are stored in a plurality of data partitions, according to some embodiments of the present invention;

FIGS. 3 and 4 are schematic illustrations of storage patterns, according to some embodiments of the present invention;

FIG. 5 is a schematic illustration of a method for accelerating the data retrieval in distributed databases, according to some embodiments of the present invention;

FIG. 6 is a schematic illustration of a distributed data management system, according to one embodiment of the present invention;

FIG. 7 is a sequence diagram of an exemplary method for searching and retrieving information from replica databases, according to a preferred embodiment of the present invention;

FIGS. 8 and 9 are a sequence diagram of a known method for acquiring data using an index and a sequence diagram of a method for acquiring data using an index to in which the number hops is reduced, according to some embodiments of the prior art;

FIG. 10 is a general flowchart of a method for incrementally generating a backup of a data partition, according to some embodiments of the present invention; and

FIG. 11 is an exemplary database with a tree dataset with child-parent relationships, according to some embodiments of the present invention.

### DESCRIPTION OF SPECIFIC EMBODIMENTS OF THE INVENTION

The present invention relates to an apparatus and method for managing a storage of data elements, and more particularly, but not exclusively to an apparatus and method for managing the distribution of data elements across a number of storage devices.

According to some embodiments of the present invention there is provided a method and a system for managing data storage in a plurality of data partitions, such as replica databases. The method is based on analyzing the received memory access queries either in real-time or at design time. This analysis is performed to determine the logical connection between the data elements and determine which data elements are commonly accessed together. The analysis allows, for one or more of the analyzed memory access queries, associating between at least one key of a respective result table and at least one of the physical data partitions. In such an embodiment, data elements are stored according to a match with respective said at least one key.

According to some embodiments of the present invention there is provided a method and a system for retrieving records from replica databases. In such a method, the editing of each record is time tagged with a last editing which is kept in each one of the replica databases and is issued by virtual partition coordinator. The tagging may be performed using counters, the coordinator also manages and distributes the last committed time tag, that is to say, the last tag that is commonly known between ALL virtual partition members, for example as described below. Now, whenever a request for a certain record is received the certain record is validating by matching between a respective the tags. If the time tag of the record is smaller than the last committed tag of the replica database that hosts it, it is clear that no changes have been done thereto.

According to some embodiments of the present invention there is provided a to method and a system for validating one or more records of a remote database. The method may be used for accelerating a majority voting process, as further described below. The method may be used for accelerating the access to indexes of a distributed database with a plurality of copies. In such an embodiment, a request for one or more records is forwarded to one or more network nodes hosting an index, such as a hash table, of a plurality of records. Then, an index response from one or more of the network nodes is received and one or more fields are extracted to allow the acquisition of a respective record. In such a manner, the time during which the sender of the request is awaited, for example for the completion of a common majority voting process, is spared. After a copy of the respective record is received, the extracted field is matched respective fields thereof. The match allows validating the received copy.

According to some embodiments of the present invention there is provided a method and a system for retrieving records in a distributed data system which is based on indexes for managing the access to records. The method is based on a request for a record that is received at a front end node of the distributed data system. After the request is received, an index request may be forwarded to a respective network node that extracts a unique identifier, such as an address, therefrom. The respective network node optionally issues a request for the related record and sends it, optionally directly, to the hosting network node. The hosting network node replies directly to the front node. I such an embodiments, redundant hops are spared. Such a data retrieval process may be used for accelerating a voting process in which a number of copies of the same record are acquired using indexes. In such an embodiment, the front end sends a single request for receiving a certain copy and intercepts a direct reply as a response.

According to some embodiments of the present invention there is provided a system for backing up a set of virtual partition. The system includes replica databases, which are designed to store a number of data elements in virtual partitions. Each virtual partition is separately stored in two or more of the plurality replica databases. The system further includes a backup management module for managing a backup component in one or more of the replica databases and a data management module for synchronizing between the plurality of copies of each said virtual partition, for example as described in pending International Patent Application Publication No. WO2006/090367, filed on Nov. 7, 2005, which is incorporated herein by reference. During the synchronizing, one or more agents are configured to manage new data replicas, for example as in the case of scaling out the system. Optionally, the agents are triggered to create one or more replicas for each virtual partition. A management component then gathers the backed up replicas into a coherent database backup.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

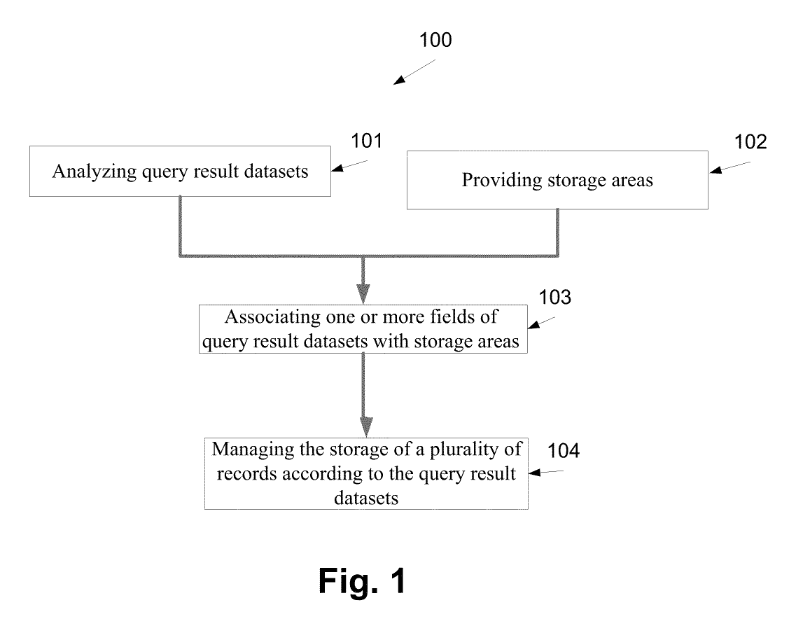

Reference is now made to FIG. 1, which is a flowchart of a method for managing data storage in a plurality of data partitions, according to some embodiments of the present invention. As used herein a data partition means a virtual partition, a partition, a virtual partition, a separable logical section of a disk, a separable physical storage device of distributed database, a server, and/or a separable hard disk or any other device that is used for storing a set of data elements which are accessed by a number of applications or is fundamental to a system, a project, an enterprise, or a business. As used herein, a data element means a data unit, a bit, a sequence of adjacent bits, such as a byte, an array of bits, a massage, a record or a file.

As described in the background sections, data elements of a distributed database, such as RDBMS, are usually stored according to their relation to preset tables which are arranged according to certain primary key and/or foreign key. In the present invention, the data elements of a certain database are stored according to their logical relation to results of queries, such as relational database queries. Usually data elements are arranged in a number of tables, each accessed using a primary key or one or a foreign key. When a database that is distributed in a number of data partitions and serves a number of applications, some of the database transactions may have high latency. For example, when an application that is hosted in a first site of a distributed storage system accesses data that is physically stored in a second site, the transaction has high geographical communication latency. Geographical communication latency may be understood as the time that is needed for a site to acquire and/or access one or more data elements from a remote destination site that hosts the requested data elements, see International Patent Application No. PCT/IL2007/001173, published on Apr. 3, 2008, which is incorporated herein by reference. Storing logically related data elements in the same virtual partition improves the transaction flow and allows simpler data access patterns. Such storage allows local access to data elements and reduces the time of sequenced access to various data elements, for example by reducing the locking time which is needed for editing a data element.

The method 100 which is depicted in FIG. 1, allows reducing the number of transactions with high communication latency by storing data elements according to their logical relations to data elements which are requested by adjacent sources to the applications that generated the respective queries. As used herein a query result dataset means data fields that match a query.

First, as shown at 101, query result datasets of common relational database queries of different applications are analyzed. Each query result dataset includes one or more fields which are retrieved in response to a respective relational database query that is associated with a respective database. Identifying the query result datasets of the common queries allows mapping the frequency of transactions which are performed during the usage of the distributed database by one or more systems and/or applications.

The analysis allows determining the frequency of submitting a certain memory access query from each one of the physical data partitions. In such a manner, the database transactions are mapped, allowing the storing of data elements in the data partitions which are effortlessly accessible to the applications and/or systems that use them, for example as described below. Optionally, the analysis is based on a schematic dataset that maps the logical connection between the types of the records which are stored in the distributed database.

The query analysis may be performed by analyzing the transaction logs of the related applications, analyzing the specification of each application and/or monitoring to the packet traffic between the applications and the respective database, for example as further described below.

As shown at 102, a plurality of potential physical data partitions are provided. As described above the physical data partitions may be partition in a common storage device, such as virtual partitions, or a storage device, such as a database server in a geographically distributed database. Each physical data partition is associated with one or more applications that have a direct access thereto.

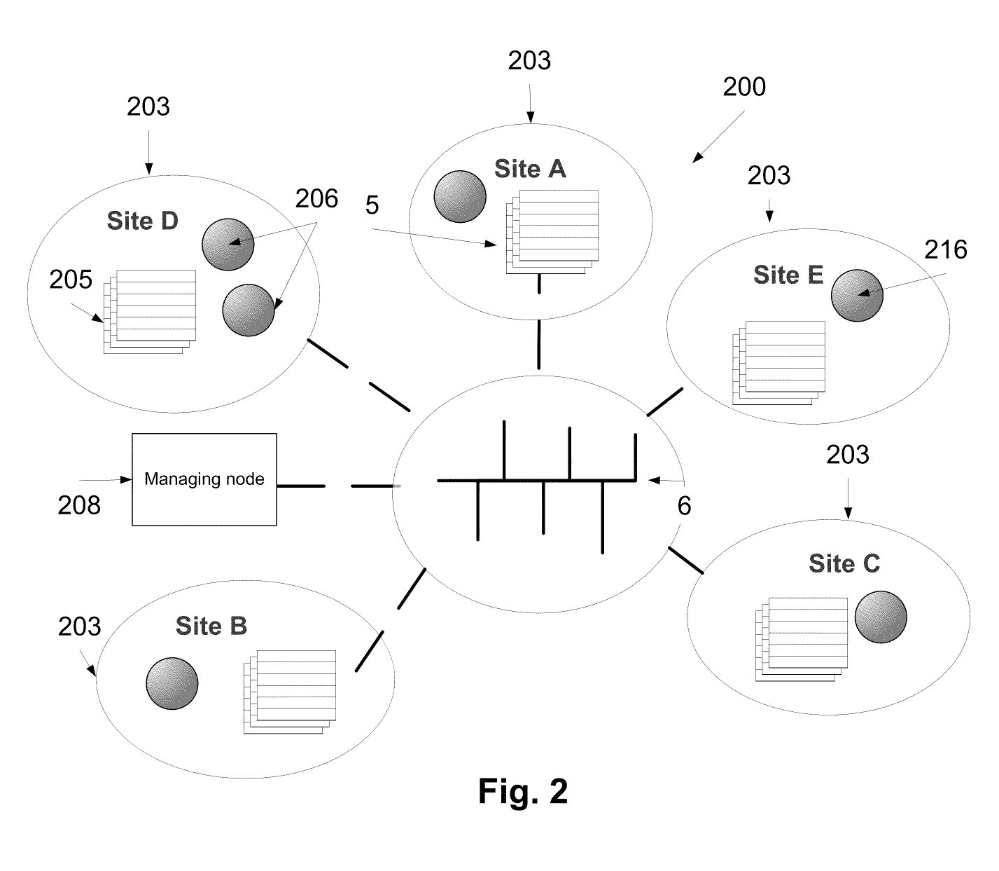

Reference is now also made to FIG. 2, which is a schematic illustration of an exemplary storage system 200 for managing a plurality of data elements which are stored in a plurality of data partitions, according to some embodiments of the present invention. Optionally, the storage system 200 is distributed across different sites 203, which may be understood as data storage sites, such as the exemplary sites A, B, C, D and E which are shown at FIG. 2, according to an embodiment of the present invention. Optionally, each one of the sites manages a separate local data management system that stores the data. The local data management system may be part of a global system for backing up data, for example as described in International Patent Application No. PCT/IL2007/001173, published on Apr. 3, 2008, which is incorporated herein by reference. Optionally, the storage system 200 is designed to manage the distribution of a globally coherent distributed database that includes plurality of data elements, wherein requests for given data elements incur a geographic inertia. It should be noted that globally coherency may be understood as the ability to provide the same data element to a requesting unit, regardless to the site from which the requesting unit requests it. A globally coherent distributed database may be understood as a distributed database with the ability to provide the same one or more data elements to a requesting unit, regardless to the site from which the requesting unit requests it. For example, International Patent Application Publication No. WO2006/090367, filed on Nov. 7, 2005, which is hereby incorporated by reference in its entirety, describes a method and apparatus for a distributed data management in a switching network that replicates data in number of virtual partitions, such that each data replica is stored in a different server.

As shown at 103, after the query result datasets have been analyzed, each data partition is associated with one or more fields of the query result datasets of the to queries. The association of each field is determined according to the frequency of submitting the respective queries. The frequency, which is optionally extracted as described above, predicts the frequency of similar queries for the respective fields. Such queries are usually done for additional fields which are usually logically related to the respective fields. For example, a query for ID information of a certain subscriber is usually followed by and/or attached with a request for related information, such as subscribed services, prepaid account data, and the like. Thus, the frequency of some queries may be used to predict the frequency of queries for logically related fields. Static and real-time approaches maybe combined to generate a logical relationship of the data into the largest possible containers.

The frequency of query result datasets may be identified and/or tagged automatically and/or manually. Optionally, a query log, such the query log general data element of the MySQL, which the specification thereof is incorporated herein by reference, is analyzed to extract statistical information about the prevalence queries. Optionally, the relevance of a query to a certain application is scored and/or ranked according to the statistical analysis of the logs. The commonly used queries are scored and/or ranked higher than less used queries. In such a manner, the most common queries reflect the transactions that require much of the computational complexity of the access to the database of the system 200. Optionally, the ranking and/or scoring is performed per application. In such a manner, the scoring and/or ranking reflects the most common queries for each application. Optionally, each data partition is associated with query result datasets of one or more queries which are commonly used by an application which have a direct access thereto. For example, some queries request a subscriber phone number for a given subscriber ID while others may request the subscriber physical telephone subscriber identification module (SIM) card number from subscriber ID. Therefore, both phone number and SIM card number should be clustered within the same physical data partition subscriber dataset and be associated with the same virtual partition In such a manner, when an application generates a transaction that is based on the query related to the query result dataset which is associated with a directly connected data partition, no geographical communication latency is incurred.

For example, site D hosts query result datasets 205 of queries which are to generated by locally host applications 206. The association determines the distribution of data elements among the data partitions. The distribution is managed in a manner that reduces the number of data retrievals with high geographical communication latency which is needed to allow a number of remotely located database clients to receive access to the plurality of data elements. A geographic inertia may be understood as a tendency to receive requests to access a certain data element from a locality X whenever a preceding request for the certain data element has been identified from the locality X. That is to say a request for data at one time from a given location is a good prediction that a next request for the same data will come from the same location.

Optionally, a managing node 208 is used for implementing the method that is depicted in FIG. 1. The managing node may be hosted in a central server that is connected to the system 200 and/or in one of the sites.

Optionally, the query result dataset is based on one or more fields that uniquely define a unique entity, such as a subscriber, a client, a citizen, a company and/or any other unique ID of an entity that that is logically connected to a plurality of data elements. Such one or more fields may be referred to herein as a leading entity. In such an embodiment, fields which are logically related to the leading entity are defined as a part of the respective query result dataset.

Optionally, a leading entity and/or related fields are defined per query result dataset. Optionally, a metadata language is defined in order to allow the system operator to perform the adaptations. Optionally, a leading key may be based on one or more fields of any of the data types.

In an exemplary embodiment of the present invention, the queries are related to subscribers of a cellular network operator. In such an embodiment, the tables may be related to a leading entity, such as a cellular subscriber, for example as follows:

TABLE A

| Subscriber | Status | Category |
|---|---|---|
| 1001 | Active | Business |
| 1002 | Active | Consumer |

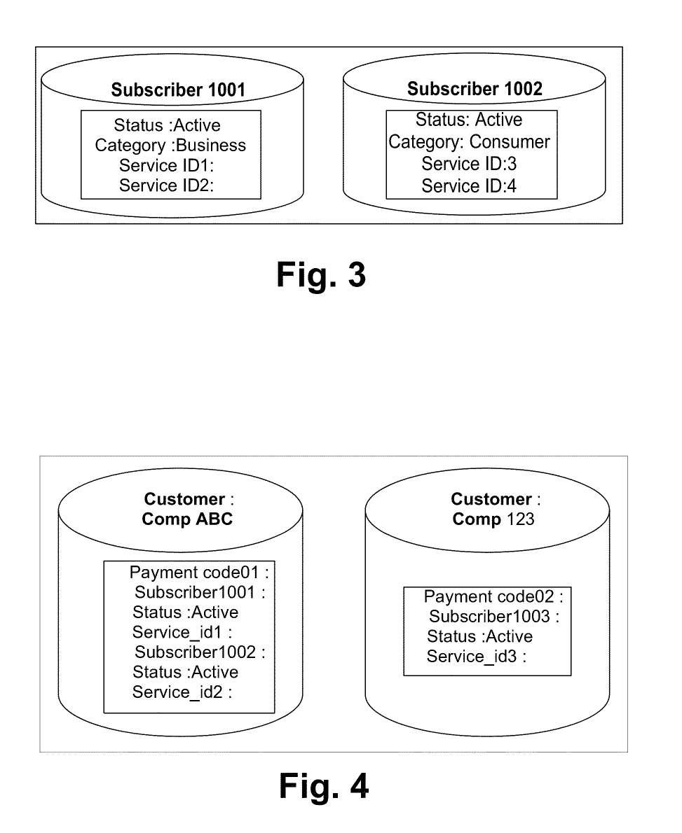

TABLE B

| Subscriber | Service_ID |
|---|---|
| 1001 | 1 |
| 1001 | 2 |
| 1002 | 3 |
| 1002 | 4 |

where table A includes subscriber profile data and table B includes service to profile data. In such an embodiment, the leading entity is “Subscriber”. Optionally, the data is stored according to the leading entity “Subscriber”, for example as depicted in FIG. 3. In such a manner, all database transactions, which are based on a query that addresses a certain subscriber, are hosted in the respective storage may be accessed locally, for example without latency, such as geographical communication latency. In such an embodiment, data elements may be stored in databases which are more accessible to the applications that send most of the queries that require their retrieval.

It should be noted that the query result dataset and/or the fields which are associated with the leading entity may include any field that is logically associated and/or connected therewith. For example, in the following tables which are related to a leading entity cellular subscriber:

TABLE A

| Customer | Payment code |
|---|---|
| ABC Comp | 01 |
| 123 Comp | 02 |

TABLE B

| Subscriber | Status | Customer |
|---|---|---|
| 1001 | Active | ABC Comp |
| 1002 | Active | ABC Comp |
| 1003 | Active | 123 Comp |

TABLE C

| Subscriber | Service_ID |
|---|---|
| 1001 | 1 |
| 1002 | 2 |
| 1003 | 3 |

where table A includes subscriber payment code, table B includes status data, and table C includes services data, the data is distributed according to the leading entity consumer, for example as depicted in FIG. 4.

In such an embodiment, the service ID of the subscriber is gathered together with other information that is related to the customer thought there is no direct logical to connection between them.

In a distributed database computing environment, data partitioning that is performed according to a commonly used leading entity and/or query result datasets which reflect the majority of the transactions reduces the average transaction latency.

Optionally, the data, which is stored in each one of the physical data storages, is independently backed up. In such an embodiment, the transactions, which are related to the data, do not or substantially do not require data elements from other physical data storages. Thus, the resources and data locks which are required in order to manage the transaction in a high atomicity, consistency, isolation, and durability (ACID) level, are reduced. In such an embodiment, locking and data manipulation may be done in a single command at a single locality, without the need to manage locks, unlocks, manipulations and/or rollback operations over separated physical locations which result in sequential operations that raises the number of hops in the operation.

Furthermore, as the data does not need to be collected from multiple data nodes, the average number of network hops per transaction may be substantially reduced. The associating of query result datasets with specific physical storage devices allows updating the database in a manner that maintains the aforementioned distribution.

Now, as shown at 104, the storage of a plurality of data elements is managed according to the association of certain query result datasets with certain data partitions. Data elements are stored in the storage device that is associated with a respective query result dataset. In such a manner, a data element that includes the telephone number of a subscriber is stored in the database of the operator that uses this information and not in a remote database that requires other data elements. In such a manner the average latency for accessing such a data element is reduced. Furthermore, the data partitions are better managed as less local copies are created during redundant data transactions.

Optionally, a managing node 205 is used for receiving the data elements and storing them in the appropriate data partition. Optionally, the managing node 205 matches each received data element with the query result datasets which are either accessed and/or locally stored by it.

In some embodiments of the present invention, the method 100 is used for managing the storage of a geographically distributed storage system. In such an embodiment, in order to maintain high ACID level, a number of copies of each data element are stored in different data partitions, see International Patent Application No. PCT/IL2007/001173, published on Apr. 3, 2008, which is incorporated herein by reference.

Though the storage management method may be used for managing a data storage in a unique manner, the access to the records may be done using lightweight directory access protocol (LDAP), extensible markup language (XML), and/or structured query language (SQL).

In some embodiments of the present invention, a distributed hash-table and/or any other index are used for locating the stored data elements according to a given key that is selected according to the attributes and/or the values thereof. The attributes and/or the values correspond with and/or bounded by a logical schema that defines the relationships between the data elements. The logical schema may be based on logged queries and/or unlisted data elements which are added manually by an administrator and/or according to an analysis of the related applications specification. The logical schema describes the types of the attributes and/or values and the relationship between them. The relationship is described in a form that is similar to an RDMS foreign key in which one or more attributes are matched with an equal set of attributes in a parent object, creating a tree dataset with child-parent relationships, for example as described in FIG. 11. Optionally, each table in the tree is stored according to an analysis of the logical connections in the logical schema, optionally as described above. Each object type in the tree dataset has one or more attributes which are defined as primary keys. In such an embodiment, a primary key for an object may be a list of keys. An object type in the schema may reside directly under a certain root with an empty parent relation and/or under a fixed path to a fixed value, for example when residing non hierarchical data.

In order to allow applications that uses RDBMS to connect to the database, an RDMS representation of the logical schema is provided. In the logical schema, each table is represented by an object type having the same name as the original table. The hierarchical relationship of the tree dataset is made as a relationship between an objectClass attribute, a built in attribute that holds the object type, and a table object type. For example, if the table has a primary key field [pk_attr], the key for accessing the respective data element is [pk_attr=‘value’, table_name=Table1, dc=com] where dc=com denotes another fixed object with a root for all tables.

In case hierarchy is defined using a foreign key, the hierarchy is considered and the tree dataset is maintained.

In order to allow applications that uses LDAP to connect to the database, an LDAP representation of the logical schema is provided. Optionally, the representation includes a hierarchical data model with no fixed primary keys. In order to coordinate between the LDAP representation and the tree dataset, optionally at run time, mockup attributes are added to each child object which, in turn, is linked to parent attributes that contain the same data. In such a manner, a foreign key of a primary key that is associated with a parent node is simulated.

For clarity, the tree dataset may be correlated with any language and/or protocol model, such as an XML model.

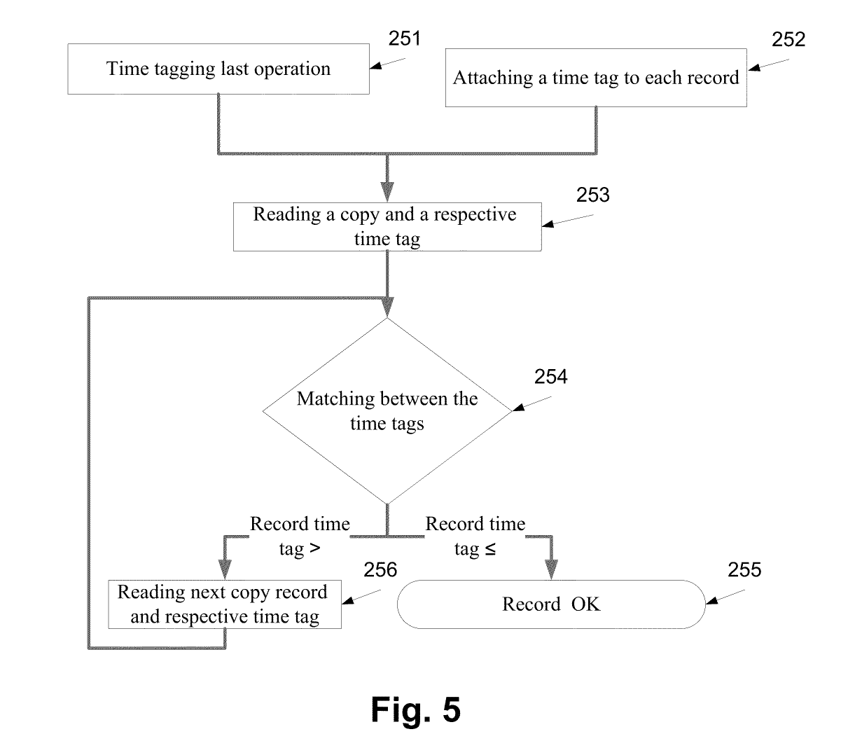

Reference is now made, once again, to FIG. 2 and to FIG. 5, which is a schematic illustration of a method for accelerating the data retrieval in distributed databases, according to some embodiments of the present invention. A distributed database may be spread over storage unit, such as computers, residing in a single geographic location and/or in a plurality of different geographic locations. As further described in the background sections, in order to maintain a high ACID level, for example in systems which are used for maintaining critical real-time data, a number of copies of each data element has to be maintained. In such systems, a majority voting.

Algorithm is used for validating the data, see International Patent Application No. WO2007/141791 published on Dec. 13, 2007, which is incorporated herein by reference. When such an algorithm is applied, a write operation usually requires updating the majority of the copies before a reply can be issued to the request issuer and later on updating all the copies. A read operation requires reading at least the majority of the copies. As described above, and implemented by the commonly used voting majority algorithm, the data element which has the highest representation among all the databases of the set of databases, is retrieved. The majority-voting process is used in order to ensure the validity of the data replica in order to assure safe completion of any read or write operation.

For example, copies of a data element which are stored in sites A, B, and C in FIG. 2 may receive a query from an application 216 on site E. In such an embodiment, the copies are forwarded to site E, thereby incurring high geographical communication latency.

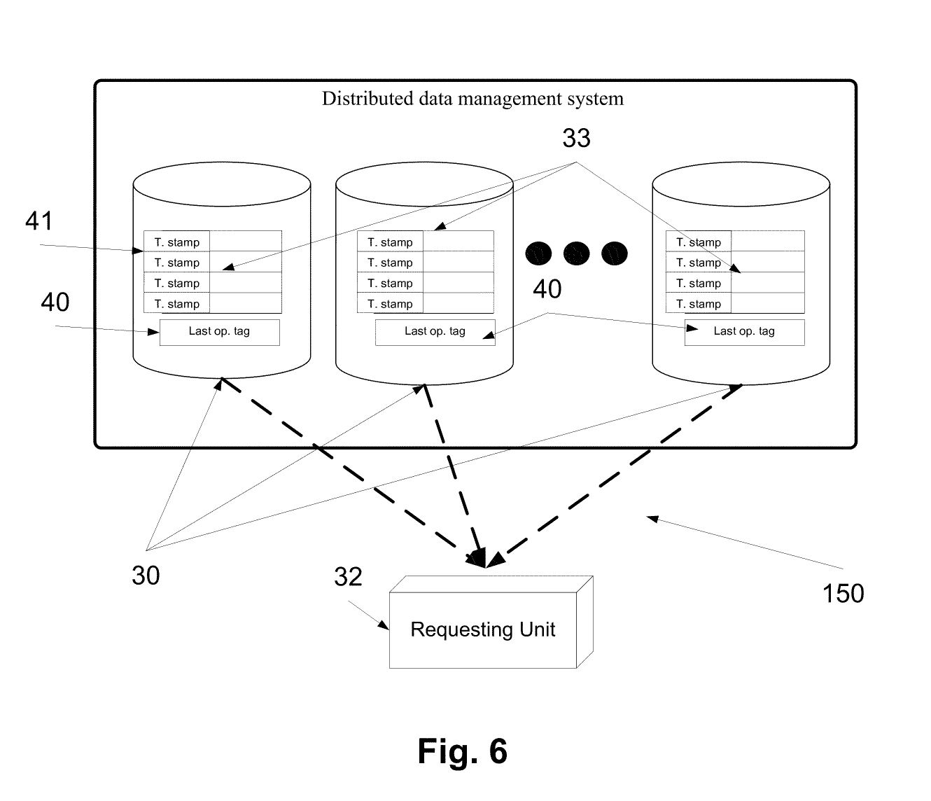

Reference is now also made to FIG. 6, which is a schematic illustration of a distributed data management system 150, according to one embodiment of the present invention. In the depicted embodiment, the distributed data management system 150 comprises a set of data partitions 30. Each data partition may be referred to herein as a replica database 30. It should be noted that each one of the replica database 30 may distributed in geographically distributed sites and communicate via communication network, such as the Internet. Optionally, the distributed data management system 150 further comprises a merging component (not shown), see international publication No. WO2007/141791 published on Dec. 13, 2007, which is incorporated herein by reference. Optionally, each one of the databases in the set 30 is part of a local data management system, for example as defined in relation to FIG. 2. The system is connected to one or more requesting units 32 and designed to receive data requests therefrom. Although only one requesting unit 32 is depicted, a large number of requesting units may similarly be connected to the system 600. The requesting unit may be an application or a front end node of a distributed system.

Optionally, each one of the replica databases 30 is defined and managed as a separate storage device. Optionally, a number of copies of the same data element are distributed among the replica databases 30. In use, the exemplary distributed data management system 150 is designed to receive write and read commands from the requesting unit 32, which may function as a write operation initiator for writing operations and/or a read operation initiator for read operations.

Operations are propagated to a coordinator of the replica databases 30. When majority of the replica databases 30 that holds the requested data element acknowledges the operation, a response is issued by the coordinator and sent to the write operation initiator. When a read operation initiator issues a request for reading a data element, the request is forwarded to all the replica databases 30 and/or to the replica databases 30 that hold a copy of the requested data element. The operation is considered as completed when responses from the majority of the replica databases 30 that hold copies of the requested data element have been received.

The method, which is depicted in FIG. 5, reduces the latency that may be incurred by such a validation process. Such a reduction may be substantial when the system is deployed over geographically distributed sites which are connected by a network, such as wide area network (WAN). In such networks, the latency of each response may accumulate to tens or hundreds of milliseconds.

First, as shown at 251, the last write operation which have been performed on each replica database 30 is documented, optionally on a last write stamp 40 that is associated by the coordinator with the respective replica database 30. Optionally, the write operations in each one of the replica databases 30 are counted to reflect which operation has been performed most recently on the respective replica database.

In addition, as shown at 252, each data element of each replica database 30 is attached with a write time stamp, such as a counter, that reflects the time it has been updated and/or added for the last time. Optionally, the write time stamp is a copy of the value of the counter of the respective replica database 30 at time it was added and/or changed. This copy may be referred to herein as a write time stamp, for example as shown at 41.

Furthermore, each replica database 30 documents and/or tags the last write operation which has been performed on one of the data elements it hosts. Optionally, each one of the replica databases 30 is associated with a last operation field that stores the last write operation, such as the last full sequential write operation, that has been performed in the respective replica database 30.

Now, as shown at 253, a read operation is performed by an operation initiator.

In some embodiments of the present invention, the read operation does not involve propagating a request to all the replica databases 30. Optionally, the read operation is performed on a single replica database 30 that hosts a single copy of the to data element. Optionally, the read operation is propagated to all copies and each reply is considered in the above algorithm. If one reply is accepted and a response thereto is issued to the requester, other replies are disregarded.

As shown at 254, if the read data element has a write time stamp 41 former to and/or equal to the respective last write stamp 40, no more read operations are performed and the data that is stored in the read data element is considered as valid. For example, of the counter 41 that is attached to the copy of the data element is smaller and/or equal to the counter of the counter of the respective replica database 40 the read copy of the data element is considered as valid. As most of the reading transactions require reading only one copy, the required bandwidth which is needed for a reading operation is reduced.

As shown at 256, if the read data element has a write time stamp 41 is greater than the respective last write stamp 40, one or more other copies of the data element are read or replies are considered in the case the read operation was issued to all nodes, optionally according to the same process, as shown at 256. This process may be iteratively repeated as long as the write time stamp 41 of the read data element is greater than the respective last write stamp 40. Optionally, a majority voting validation process is completed, for example as described in international publication No. WO2007/141791, if the write time stamp 41 is greater than the respective last write stamp 40.

In some embodiments of the present invention, the read operation involves propagating a request to all the replica databases 30. In such an embodiment, as described above, all the copies are retrieved to the operation initiator. Optionally, blocks 254 and 256 are performed on all the received copies in a repetitive manner as long as the write time stamp 41 of the read data element is greater than the respective last write stamp 40.

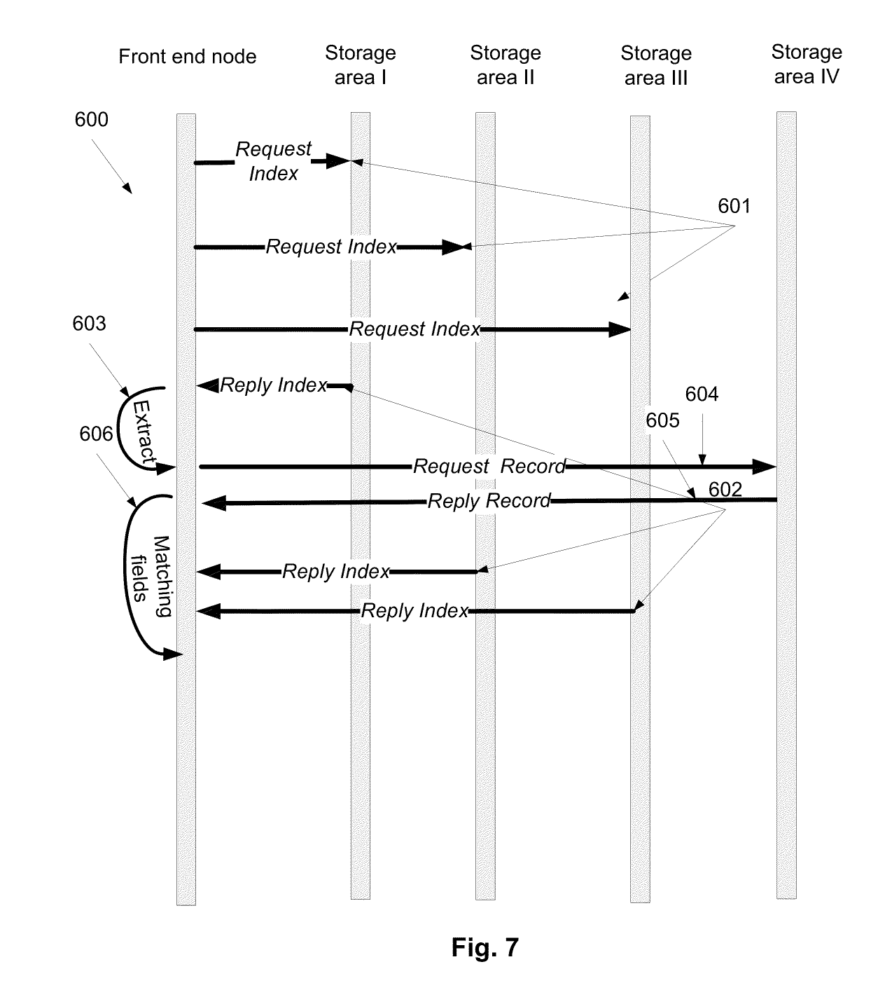

Reference is now made to FIG. 7, which is a sequence diagram of an exemplary method 600 for searching and retrieving information from replica databases, according to a preferred embodiment of the present invention. In some embodiments of the present invention, the physical storage address of one or more data elements is acquired using an index, such as a hash table, that associates keys with values. In order to maintain a high availability, a number of copies of the index to are maintained in different data partitions, such as replica databases. Usually, a majority voting algorithm is used for allowing the reading of respective values from at least the majority of copies of the index. It should be noted that as indexes are considered regular records in the database, any other read methodology may be used. In such embodiments, a set of data elements, which copies thereof are optionally distributed among a plurality of replica databases, is associated with the index, such as a hash table or a look up table (LUT). Optionally, a number of copies of the set of records are stored in the replica databases and the copies of each value are associated with a respective key in each one of the indexes. Optionally, a common function, such as a hashing function, is used for generating all the indexes at all the replica databases, see international publication No. WO2007/141791 published on Dec. 13, 2007, which is incorporated herein by reference. By using the keys which are encoded in the indexes, the majority voting algorithm and/or similar algorithms may be accelerated.

As shown at 601, the operation initiator sends a request for a data element, such as a value, to a front end network node. The front end network node sends one or more respective index requests to the replica databases 30. Optionally, the request is for a value that fulfills one or more criterions, such as an address, a range of addresses, and one or more hash table addresses, etc.

As shown at 602, each one of the replica databases 30 replies with an address a matching value from its respective index. As shown at 603, the first index response that is received is analyzed to extract one or more data fields, such as an ID number field, a subscriber ID field and the like for detecting the virtual partition of the respective data elements.

For example, if the index is a hash table, the one or more fields which are documented in the hash table are used as an index in an array to locate the desired virtual partition, which may be referred to as a bucket, where the respective data elements should be. In such an embodiment, the one or more fields are used for acquiring the related data element. The one or more fields are extracted from the first index response and used, for example as an address, for acquiring the data element, as shown at 604 and 605. Unlike a commonly used process, in which a majority voting algorithm is performed on all or most of the received index responses, the matching address is extracted substantially after the first response is received, without a voting procedure. In such a manner, the process of acquiring the data element may be performed in parallel to the acquisition of index responses to the index requests. As shown at 606, after the requested data element is received, optionally at the front node, one or more matching addresses, which are received from other index responses, are matched with one or more respective fields and/or attributes in the data elements. If the match is successful, the data element is considered as valid. Else the majority voting process may be completed (not shown), for example as described in international publication No. WO2007/141791, published on Dec. 13, 2007, which is incorporated herein by reference. The method 600 allows the front end network node to verify the validity of the data element prior to the completion of a majority voting process. Optionally, not all the index responses and/or the copies of the requested record are received. In such a manner, the majority voting process may be accelerated and the number of transactions may be reduced.

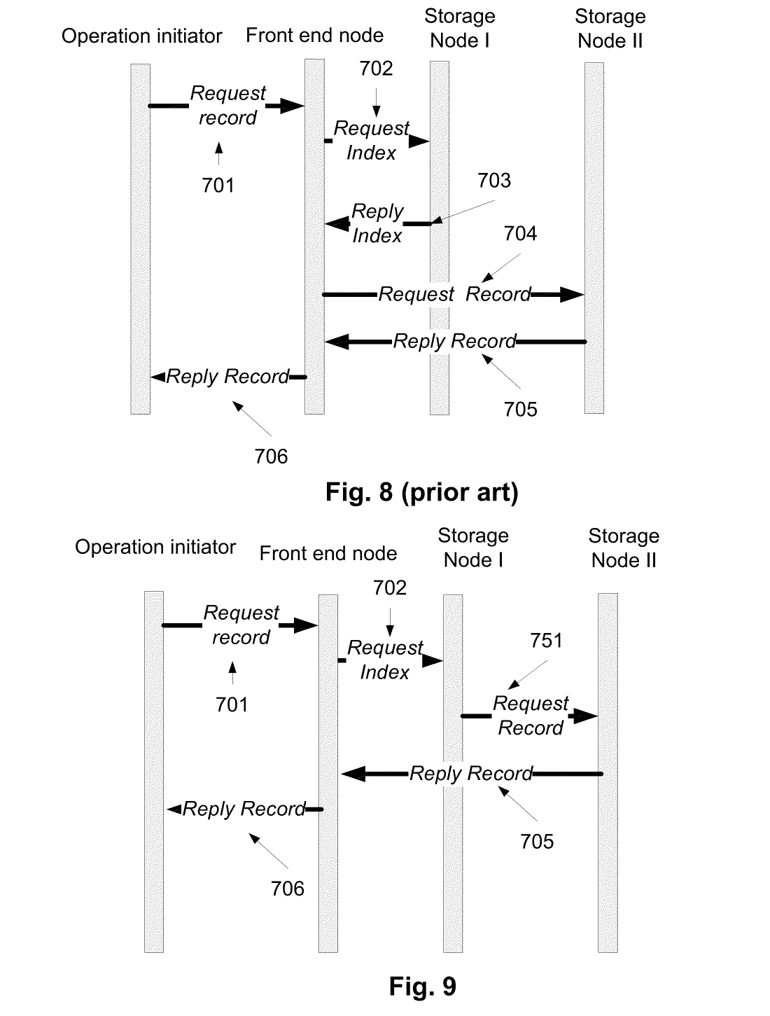

Reference is now made to FIGS. 8 and 9, which are respectively a sequence diagram of a known method for acquiring data using an index and a sequence diagram of a method for acquiring data using an index in which the number hops is reduced, according to some embodiments of the prior art.

As depicted in FIGS. 8 and 9, a distributed data system that includes a plurality of replica databases, for example as described in international publication No. WO2007/141791, published on Dec. 13, 2007, which is incorporated herein by reference. The system has one or more front end nodes each designed to receive read and write operation requests from one or more related applications.

The application, which may be referred to herein as a read operation initiator 701, sends the request to the front end node. In the known method, as shown at 702, the front end network node sends an index request that is routed to one or more data partitions that host copies of the index, for example as described above in relation to FIG. 7. As shown at 703, an index response that includes an address and/or any pointer the physical storage of the requested data element is sent back to the requesting front end network node. Now, as shown at 704 and 705, the front end network node extracts the physical address of the requested data and uses it for sending a request for acquiring the data element to the respective data partition. As shown at 706, the received data element is now forwarded to the requesting application.

In order to reduce the number of hops which are described above in relation to FIG. 8, the data partition that host the index is configured for requesting the data element on behalf of the front end network node. As depicted in FIG. 9, the storage node that hosts the index generates a request for the data element according to the respective information that is stored in its index and forwards it, as shown at 751, to the storage node that hosts it. Optionally, the transaction scheme, which is presented in FIG. 8, is used for acquiring data elements in distributed database systems that host plurality of indexes. In such an embodiment, the scheme depicts the process of acquiring a certain copy of the requested record by sending the index request 702 to one of the replica databases that hosts a copy of the index. Each one of the requests 751 designates the front end node as the response recipient. Optionally, the requests are formulated as if they sent from the network ID of the front end node. The hosting data partition sends the requested data element to the requesting front end network node. In such a manner, the front end network node may receive a plurality of copies of the data element from a plurality of replica databases and performs a majority voting to validate the requested data element before it is sent to the application. As the hops which incurred by the transmission of the index responses to the front end network node are spared, the latency reduces and the majority voting is accelerated.

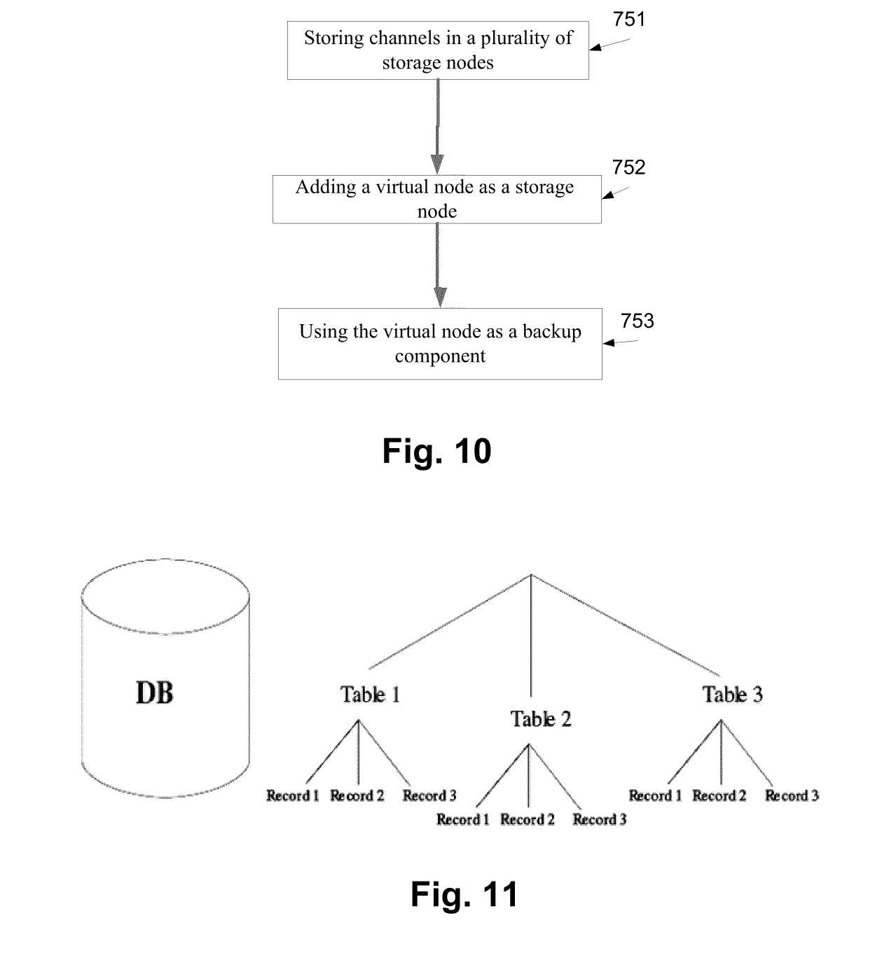

Reference is now made to FIG. 10, which is a flowchart of a method for backing up data partitions, according to some embodiments of the present invention. As commonly known and described in the background section distributed data systems, which are used for maintaining critical real-time data, are expected to be highly available, scalable and responsive. Examples for such a distributed data system are provided in US Patent Application Publication No. 2007/0288530, filed on Jul. 6, 2007, which is incorporated herein by reference.

The backup method, which is depicted in FIG. 10, provides a method for incrementally generating a backup of a data partition, such as a virtual partition, according to some embodiments of the present invention. The method may be used instead of doing a re-backing up all the data in each one of the backup iterations. The to method allows synchronizing a backup process in a plurality of distributed data partitions to generate a consistent image of the distributed database.

Optionally, the distributed database includes front end nodes, storage entities, and a manager for managing the back-up process. As used herein, a storage entity means a separate storage node such as an XDB, for example as described in US Patent Application Publication No. 2007/0288530, filed on Jul. 6, 2007, which is incorporated herein by reference. In the present method, each backup component is synchronized as a separate storage entity of a distributed database, for example as a new XDB in the systems which are described in US Patent Application Publication No. 2007/0288530. These backup components may be used for generating an image of the entire distributed database with which they have been synchronized.

As also shown at 751, the distributed database holds data in a plurality of separate virtual partitions, which may be referred to as channels. Each channel is stored by several storage entities for high availability purposes. The manager is optionally configured for initiating a back-up process for each one of the channels. Optionally, the backups of the channels create an image of all the data that is stored in the database. Optionally, the manager delegates the backup action to a front end node, such as an XDR, for example as defined in US Patent Application Publication No. 2007/0288530, filed on Jul. 6, 2007, which is incorporated herein by reference.

As shown at 752, the new backup component, which is optionally a defined in a certain storage area in one of the storage entities, joins as a virtual storage entity, such as a virtual XDB that is considered for the read/write transaction operations, as an additional storage entity. In such an embodiment, the backup of a certain channel may be initiated by a front end node that adds a new XDB to the distributed storage system, for example as defined in aforementioned US Patent Application Publication No. 2007/0288530. As a result, the data of the virtual partition is forwarded, optionally as a stream, to the virtual storage node. The synchronization process includes receiving data, which is already stored in the virtual partition, and ongoing updates of new transactions. For example, if the distributed system is managed as described in US Patent Application Publication No. 2007/0288530, a write transaction that is related to a certain channel is sent to all the storage nodes which are associated with the certain channel, including to the virtual storage node that is associated therewith. Optionally, the write operation is performed according to a two-phase commit protocol (2PC) or a three-phase commit protocol (3PC), which the specification thereof is incorporated herein by reference.

It should be noted that the virtual storage does not participate in read operations. The result of such a backup process is a set of virtual storages, such as files, that contain an image of the database. As shown at 753, these files may then be used to restore the database. Each file contains an entire image of one or more virtual partitions while the restoration is not dependent upon the backup topology. To restore a virtual partition or an entire database image, the manager may use the respective virtual storage nodes.

As described above, the write transactions are documented in the virtual storage nodes. As such, the backup may be implemented as a hot backup, also called a dynamic backup, which is performed on the data of the virtual partition even though it is actively accessible to front nodes. Optionally, the manager adjusts the speed of the backup process to ensure that the resource consumption is limited.

As transactions are continuously sent to the backup component, it is possible to synchronize all backup components to continue to process transactions even when they have received all previous data on the virtual partitions. This allows synchronizing the completion point of the backup process across all backup components to provide a single coherent image across the entire database.

It is expected that during the life of a patent maturing from this application many relevant systems and methods will be developed and the scope of the term database, data element, memory and storage are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel to characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of managing storage of a plurality of records, comprising:
providing a plurality of data tables, each said data table stores a plurality of data element sets, each said data element set comprises a plurality of data elements which are logically associated with one of a plurality of unique entities;
selecting at least one key for each said data table;
matching, using a processor, among said plurality of data tables using respective said at least one key;
analyzing said plurality of matched data tables to identify a plurality of groups each includes a plurality of data element sets, each comprises a plurality of data elements, from said plurality of matched data tables which are logically associated with one of said plurality of unique entities; and
distributing said plurality of data element sets of each said data table in a plurality of data partitions so that data elements of each said group being stored in one of said plurality of data partitions.

2. The computerized method of claim 1, wherein said plurality of data partitions are geographically distributed.

3. The computerized method of claim 1, wherein said plurality of data partitions are a plurality of physical partitions.

4. The computerized method of claim 1, wherein said plurality of data partitions are plurality of virtual partitions.

5. The computerized method of claim 1, wherein said at least one key is selected according to a logical schema defining a plurality of logical relations among a plurality of data fields of said plurality of data tables and a plurality of keys which comprise said at least one key.

6. The computerized method of claim 1, wherein said associating comprises generating a tree dataset of a plurality of keys which comprise said at least one key, said at least one key being defined in said plurality of keys.

7. The computerized method of claim 6, wherein each record of said tree dataset is associated a respective record in a relational schema, further comprising receiving a relational query for a first of said plurality of data elements and acquiring said first data element using a respective association between said relational schema and said tree dataset.

8. The computerized method of claim 6, wherein each record of said tree dataset is associated a respective record in an object schema, further comprising receiving a relational query for a first of said plurality of data elements and acquiring said first data element using a respective association between said object schema and said tree dataset.

9. The computerized method of claim 1, wherein said data element set of data elements are associated is based on statistical data of a plurality of memory access queries.

10. The computerized method of claim 1, wherein each said data partition is independently backed up.

11. The computerized method of claim 1, wherein said selecting comprises:
performing an analysis of a plurality of memory access queries received for accessing said plurality of data tables;
determining which of said plurality of data elements in said plurality of data tables are commonly accessed together according to said analysis and setting a plurality of logical connections between said plurality of data elements accordingly; and
selecting said at least one key according to said plurality of logical connections.

12. The computerized method of claim 1, wherein said at least one key is mapped in a schematic dataset that maps a logical connection between types of said plurality of data elements.

13. The computerized method of claim 1, further comprising managing a distributed index for locating any of said plurality of data elements according to a given key.

14. A storage system of managing storage of a plurality of records, comprising:
a plurality of geographically distributed data partitions which hosts a plurality of data tables, each said data table stores a plurality of data element sets, each of a plurality of data elements, each said data element set is logically associated with one of a plurality of unique entities; and
at least one managing node which communicates with said plurality of geographically distributed data partitions and matches between said plurality of data tables, analyzes said plurality of matched data tables to identify a plurality of groups each includes data element sets from said plurality of matched data tables which are logically associated with one of said plurality of unique entities and distributes said plurality of data element sets of each said data table among said plurality of geographically distributed data partitions so that data elements of each said group being stored in another of said plurality of geographically distributed data partitions.

15. The storage system of claim 14, wherein said plurality of data partitions are geographically distributed.

16. The storage system of claim 14, wherein said plurality of data partitions are a plurality of physical partitions.

17. The storage system of claim 14, wherein said plurality of data partitions are plurality of virtual partitions.

18. The storage system of claim 14, wherein each said data partition is independently backed up.

19. A computer program product for g managing storage of a plurality of records, comprising:
a computer readable storage medium;
first program instructions to provide a plurality of data tables, each said data table stores a plurality of data element sets, each said data element set comprises a plurality of data elements which are logically associated with one of a plurality of unique entities;
second program instructions to select at least one key for each said data table;
matching, using a processor, among said plurality of data tables using respective said at least one key;
third program instructions to analyze said plurality of matched data tables to identify a plurality of groups each includes a plurality of data element sets, each comprises a plurality of data elements, from said plurality of matched data tables which are logically associated with one of said plurality of unique entities; and
fourth program instructions to distribute said plurality of data element sets of each said data table in a plurality of data partitions so that data elements of each said group being stored in one of said plurality of data partitions;
wherein said first, second, third and fourth program instructions are stored on said computer readable storage medium.
